(19) United States
(12) Patent Application Publication
(10) Pub. No.: US 2024/0316633 A1
(43) Pub. Date: Sep. 26, 2024

(54) METHOD AND DEVICE FOR PRODUCING HARD-METAL PRESSED ARTICLES

(71) Applicant: HORN HARTSTOFFE GMBH, Tuebingen (DE)

(72) Inventors: Stefan FEISTRITZER, Gomaringen (DE); Dieter HERMES, Rottenburg (DE)

(21) Appl. No.: 18/736,884

(22) Filed: Jun. 7, 2024

Related U.S. Application Data
(63) Continuation of application No. PCT/EP2022/084916, filed on Dec. 8, 2022.

(30) Foreign Application Priority Data
Dec. 10, 2021 (DE) 10 2021 132 676.1

(51) Int. Cl. B22F 5/00; B22F 3/00; B22F 3/02; B22F 3/03

(52) U.S. Cl. CPC B22F 5/00; B22F 3/004; B22F 3/02; B22F 3/03; B22F 2005/001; B22F 2998/10

(57) ABSTRACT

A method for manufacturing hard-metal pressed articles includes providing a die that forms a cavity for producing a pressed article with at least one cutting edge and at least one chip breaker groove that is associated with a chip space. The step of providing the die providing a movable mold part and a movable mold body. The mold part has an operative surface, wherein the mold part at least sectionally defines the shape of a pressed article with the operative surface, and wherein the mold part is feedable in a first feed direction. The mold body has a rod-shaped operative section for producing a through-hole in the pressed article, wherein the mold body is feedable in a second feed direction. The first feed direction and the second feed direction are inclined at an angle of at least 45° to each other. The pressed article is formed from a hard-metal powder that is introduced into the cavity and compressed there in at least one main pressing direction. Forming the pressed article comprises feeding the mold part and the mold body such that the mold body is positioned in the cavity with the operative section being disposed in an abutment area on the mold part in a powder-tight relative position. A device enables the manufacture of hard-metal pressed articles.

### CROSS-REFERENCE TO RELATED APPLICATIONS

This application is a continuation of international patent application PCT/EP2022/084916, filed on Dec. 8, 2022, and designating the U.S., which international patent application has been published in German language and claims priority from German patent application 10 2021 132 676.1, filed on Dec. 10, 2021. The entire contents of these priority applications are incorporated herein by reference.

### BACKGROUND

The present disclosure relates to a method and device for producing hard-metal pressed articles. The present disclosure further relates to the production of raw parts for sintering components made of hard metals, particularly cutting tools. Cutting tools may include cutting inserts, indexable inserts, and the like for turning, milling, drilling, etc.

A method and a device for producing a hard-metal pressed article are known from U.S. patent application US 2019/0015900 A1. Methods and devices for producing hard-metal pressed articles for cutting tools that comprise a central through-hole are known from U.S. patent application US 2019/0232593 A1 and U.S. patent application US 2013/0039798 A1. The through-hole is produced by two opposing mold bodies with parallel feed directions.

Cutting tools made from hard metals are generally sintered at high temperatures. Various methods are known for producing accurately shaped intermediates, which are also referred to as pressed articles, raw parts, or green bodies. One method involves the primary forming using injection molding. Another approach involves producing accurate cross-sections using extrusion molding, whereby these parts must be further processed to achieve the final tool shape. Another approach involves producing pressed articles by pressing. The present disclosure primarily relates to the pressing of hard metal powder at high pressure to produce pressed articles for the powder metallurgical production of cutting tools and the like.

In mechanical machining with cutting tools, the supply of coolants and lubricants (lubricoolants) is of high importance for productivity, tool life, and achievable accuracies. Coolants and lubricants reduce friction and help to dissipate heat from the machining site (from the workpiece and tool). Eventually, coolants and lubricants can also remove chips and other debris from the machining site.

There is often a desire to introduce coolants and lubricants as close as possible to the machining site. In this way, for example, lubricoolant consumption can be optimized. This can be advantageous in terms of costs and potential environmental impact.

For the delivery of coolants and lubricants at the desired location and with the desired direction and/or spray shape, established solutions exist, such as the so-called Loc-Line system from Lockwood Products Inc., Lake Oswego, OR, USA. The system includes flexible arms with integrated fluid channels that are deformable in three dimensions and can be equipped with nozzles.

However, such systems are not suitable for every type of application and not for every type of tool. For example, in internal machining, such systems reach their limits. Another approach involves providing fluid channels directly in the tool. In this way, coolants and lubricants can be brought very close to the machining site. Furthermore, coolants and lubricants can cool the cutting tool “from the inside.”

As previously indicated, cutting tools cannot be manufactured with arbitrary degrees of freedom. The materials used (hard metals and the like) require specific manufacturing processes and forming processes.

Cutting inserts with integrated cooling channels are known, for example, from U.S. patent application US 2002/0106250 A1. European patent application EP 2 865 472 A1 discloses a machining tool with an integrated coolant circuit, wherein a first channel for supply and a second channel for return of coolant lubricant are provided.

The integration of lubricoolant channels in cutting tools is known. However, it has been observed that compromises in design are often necessary for manufacturing reasons. Furthermore, the formation of lubricoolant channels is often associated with additional manufacturing steps and therefore significant additional costs. Devices (tools) for producing pressed articles cannot be arbitrarily complex, so various boundary conditions must also be considered in their design.

In view of this, it is an object of the present disclosure to present a method for producing hard-metal pressed articles for the production of cutting tools with at least one integrated through-hole.

It is a further object of the present disclosure to present a corresponding device for producing hard-metal pressed articles for the production of cutting tools with at least one integrated through-hole.

It is a further object of the present disclosure to present a method and a device for producing hard-metal pressed articles having a through-hole that is usable as a lubricoolant channel in the resulting cutting tool.

It is a further object of the present disclosure to present a method and a device for producing hard-metal pressed articles, where the through-hole is positioned favorably within the resulting cutting tool.

It is a further object of the present disclosure to present a method and a device for producing hard-metal pressed articles, where the through-hole enables efficient supply of lubricoolant fluids and similar substances to a cutting site.

It is a further object of the present disclosure to present a method and a device for producing hard-metal pressed articles, wherein the formation of the through-hole hole can be integrated into the pressing process for producing the pressed article with only limited additional effort.

It is a further object of the present disclosure to present a method and a device for producing hard-metal pressed articles, where the through-hole can be provided in the resulting cutting tool with little or no post-processing after the pressing in the die.

### SUMMARY

According to a first aspect, these and other objects are achieved by a method for producing hard-metal pressed articles, particularly for producing sinter raw parts for cutting tools, comprising the following steps:
providing a die that forms a cavity for producing a pressed article with at least one cutting edge and at least one chip breaker groove associated with a chip space, comprising:
   providing a movable mold part, particularly a punch or slider, that at least partially defines the shape of a pressed article with an operative surface, wherein the mold part is feedable in a first feed direction,
   providing a movable mold body with a rod-like operative section for creating a through-hole, wherein the rod-like operative section particularly has a front face, wherein the mold body is feedable in a second feed direction, wherein the first feed direction and the second feed direction are inclined at an angle of at least 45° to each other,
forming the pressed article from a hard metal powder introduced into the cavity and compressed there in at least one main pressing direction, comprising:
   feeding the mold part and the mold body such that the mold body is positioned in the cavity with its operative section in an abutment area on the mold part in a powder-tight manner to form the through-hole.

According to another aspect, the above and other objects are achieved by a device for producing hard-metal pressed articles, particularly for producing sinter raw parts for cutting tools, wherein the device comprises:
a die that forms a cavity for producing a pressed article with at least one cutting edge and at least one chip breaker groove associated with a chip space, comprising
   at least one movable mold part, particularly a punch or slider, that at least partially defines the shape of a pressed article with an operative surface, wherein the mold part is feedable in a first feed direction,
   a movable mold body with a rod-like operative section for creating a through-hole, wherein the rod-like operative section particularly has a front face, wherein the mold body is feedable in a second feed direction,
   wherein the first feed direction and the second feed direction are inclined at an angle of at least 45° to each other,
   wherein the cavity can be filled with a hard metal powder,
   wherein the device has at least one pressing direction for compressing the hard metal powder introduced into the cavity, and
   wherein the mold part and the mold body are feedable such that the mold body in the cavity with its operative section is positioned in an abutment area on the first mold part in a powder-tight manner for forming the through-hole.

According to an exemplary embodiment, the device is configured to perform the method according to one of the aspects mentioned herein. It is understood that the method and the device according to the present disclosure can be similarly configured and further developed. This applies in particular to exemplary embodiments explained below, which can be applied both in the method according to the present disclosure and in the device according to the present disclosure. The device typically has a control unit (sequence control) for controlling the pressing process. In this way, procedural aspects and device aspects can be combined.

According to another aspect, the present disclosure relates to hard-metal pressed articles that have been produced according to at least one embodiment of the method described herein.

The through-hole can also be referred to as a through opening, through bore, or as a channel (provided with a closed cross-section). In exemplary embodiments, the through-hole serves as a lubricoolant through-hole. In other words, the through-hole in exemplary embodiments is intended for the targeted supply of coolants and lubricants (lubricoolant fluid). The through-hole is particularly not an open channel, trough, or groove. The through-hole has at least sectionally a closed cross-section.

The method and the device according to the present disclosure allow the integration of the through-hole in the pressed article during the pressing process. In other words, the through-hole does not have to be produced by machining in a subsequent processing step.

The provision of the mold part that is, for example, designed as a punch or slider, and the further mold body that defines the through-hole can be carried out in such a way that the mold body and consequently the through-hole are favorably positioned with respect to the cutting edge and the chip breaker groove of the pressed article.

The powder-tight positioning of the operative section, particularly the front face of the mold body, with respect to the abutment area of the mold part allows the production of a continuous hole without the need to remove any remaining residual wall or “skin” before the outlet of the through-hole.

The powder-tight abutment of the operative section of the mold body in the abutment area of the mold part serves to form the through-hole. In this way, an outlet of the through-hole towards the mold part can be produced. The powder-tight abutment between the operative section of the mold body and the abutment area of the mold part occurs within the cavity. In other words, during compression, the hard metal powder surrounds a contact area between the mold part and the mold body where the powder-tight abutment takes place.

The feed directions of the mold part and the mold body are inclined with respect to each other by at least 45°. This includes inclination angles between 45° and 135°, thus an angle of 90°+/-45°. In other words, the feed directions of the mold part and the mold body are inclined obtusely to each other. In exemplary embodiments, the feed directions of the mold part and the mold body are orthogonal or substantially orthogonal to each other (corresponding to an inclination angle of 90° and/or perpendicular to each other).

According to the foregoing embodiments, there is no parallelism between the first feed direction and the second feed direction. Accordingly, angles of 0°, 180°, and multiples thereof are not included in the inclination of at least 45° between the feed directions of the mold part and the mold body.

The chip breaker groove can also be referred to as a chip guide surface and is, for example, a step incorporated directly behind the tool's cutting edge. The chip breaker groove typically serves to guide and break the chips. Favorable chip removal increases operational safety (prevention of long chips). The thermal conditions during processing can also be favorably influenced.

In the context of the present disclosure, “powder-tight” refers to an abutment of the mold body on the mold part with a very small remaining gap. The size of the permissible remaining gap is based on the size (for example, average diameter, expected smallest diameter) of the hard metal powder used. It shall be reliably prevented that particles or grains of the powder enter the gap between the mold body and the mold part. The remaining gap is adapted to the usual grain sizes and/or granulate sizes of the hard metal powder used. For example, the hard metal powder is present in compact granular particles (for example, granulate balls), where usual average diameters are about 50 μm (micrometers) to 500 μm (micrometers).

During the pressing process, these balls are split into hard metal powder with a smaller grain diameter. However, this hard metal powder is only free-flowing a limited extent. Consequently, penetration into the “powder-tight” gap is not very likely, so that overall, the desired process capability is ensured.

According to an exemplary embodiment, the powder-tight positioning/abutment includes a gap of a maximum of 15 μm (micrometers) between the operative section of the mold body and the abutment area of the mold part. According to an exemplary embodiment, the powder-tight positioning/abutment includes a gap of a maximum of 10 μm (micrometers) between the operative section of the mold body and the abutment area of the mold part. According to an exemplary embodiment, the powder-tight positioning/abutment includes a gap of a maximum of 5 μm (micrometers) between the operative section of the mold body and the abutment area of the mold part.

In certain embodiments, the method and the device use precisely controllable axes for positioning the mold part and the mold body in the die. By way of example, the positioning accuracy is +/−1 μm (micrometer).

Feeding generally involves positioning the mold part and the mold body in connection with that shaping of the pressed article. This may involve the actual compression process (pressing movement). However, this may also involve movements that are not directly involved in compressing (positioning movement, possibly also demolding).

According to an exemplary embodiment, the mold body is rod-shaped, at least in its operative section. The rod-shaped form is adapted to the desired shape of the through-hole. The mold body is, for example, designed as a slider that forms the through-hole. The feed direction of the mold body defines the main extension direction of the through-hole, at least in exemplary embodiments. The operative section is exemplarily configured as a projection along the feed direction of the mold body, although a tapering is also conceivable.

In an exemplary embodiment, an inner contour of the through-hole is predominantly, in particular exclusively, determined by the design of the mold body with the operative section, wherein a front face of the pressed article in the area of an outlet of the through-hole towards the mold part is defined by the mold part.

In an exemplary embodiment, the mold body, at least in its operative section, has a length-diameter ratio of at least 3:1. In an exemplary embodiment, the mold body, at least in its operative section, has a length-diameter ratio of at least 5:1. In an exemplary embodiment, the mold body, at least in its operative section, has a length-diameter ratio of at least 8:1. According to these embodiments, at least the operative section of the mold body is rod-shaped with pronounced longitudinal extension.

The mold body is, for example, in its operative section cylindrically shaped with essentially constant cross-section along the longitudinal extension. This can nevertheless include demolding tapers and the like. It is generally also conceivable to design the mold body in its operative section conically or otherwise with a taper towards the abutment area. As long as the mold body is demoldable, such designs are conceivable. Therefore, the mold body can generally also include steps (diameter leaps), shoulders, and the like. The cross-section of the mold body in the operative area is, for example, circular, oval, polygonal, as a body of constant width, or similarly designed. Round or oval cross-sections may be suitable, depending on the loads occurring during the pressing process.

The mold part is, for example, designed as a punch (punch part) or as a slider. The mold part can generally also be referred to as a counterpart, abutment piece, or detent piece for the mold body in the context of the present disclosure. In hard metal pressing, there is sometimes no sharp distinction between punches and sliders. Typically, a slider is a component that is not moved during the pressing process. The forces required for pressing/compacting the hard metal powder are primarily generated by one or more punches. However, it is not excluded that components primarily functioning as sliders are moved during the pressing process, at least to a limited extent. Conversely, it is not excluded that punches are at least temporarily fixed (i.e., not moved) during the pressing process. However, despite this conceptual vagueness, the division into sliders and punches is familiar to the skilled person, so that within the scope of the present disclosure, use is made of this division to describe certain embodiments.

An edge or cutting edge of the pressed article is regularly located in a main parting plane or other mold parting, at least sectionally. A main parting plane is, for example, defined by a punch and another (stationary or movable mold part). Therefore, based on the main pressing direction (at least of a punch or main punch), certain boundary conditions regularly arise for the course of the cutting edge and the chip breaker groove spatially connected to it.

The cutting edge is usually oriented orthogonally or obtusely with respect to the main pressing direction. Since the feed direction of the mold body and the feed direction of the mold part are also obtusely (including orthogonally) oriented to each other according to the present disclosure, a lubricoolant channel formed by the through-hole can be favorably brought close to the chip breaker groove adjacent to the cutting edge.

The chip breaker groove is exemplarily arranged as a complexly shaped chip breaker groove, at least in certain embodiments. This includes, for example, a chip trough with a curvature in several planes (3D curvature). Furthermore, this can include a combination of several cutting edges and consequently several chip breaker grooves.

The powder-tight abutment of the mold body on the mold part can include a flush abutment of the front face of the mold body on the abutment area of the mold part. By way of example, the front face and the section of the abutment area facing it are flat/planar. Matched contours/curvatures are generally also conceivable as long as the gap required for powder-tight abutment is maintained.

However, it is generally also conceivable that the powder-tight abutment of the mold body on the mold part includes the engagement of the front face of the mold body in a recess in the mold part. Also in this way, a gap (for example, a circumferential gap) is provided that ensures the powder-tight abutment.

According to an exemplary embodiment of the method or the device, the mold body is positioned in the cavity such that the resulting through-hole is directed towards the chip space. In this way, a favorable feed direction for the lubricoolant fluid is achieved. The lubricoolant fluid can reach the cutting edge. The lubricoolant fluid can wet the chip space, dissipate heat there, and also contribute to the removal of chips.

According to an exemplary embodiment of the method or the device, the mold body is positioned in the cavity such that the resulting through-hole is directed towards the chip breaker groove, and wherein the cross-section of the through-hole protrudes by at least 20% over the chip breaker groove when viewed from an outlet opening along a plane that is orthogonal to the direction of the cutting motion and contacts the cutting edge. The viewing plane is exemplarily orthogonal to this plane and parallel to the direction of the cutting motion.

In a machining tool for machining by cutting, there is regularly a defined relative movement between the workpiece and the tool. A characteristic component of this movement is the cutting motion, which is related to the cutting speed, a relevant machining parameter. The direction of the cutting motion is also the direction in which the main cutting force builds up on the cutting tool, at least in exemplary embodiments.

With an overlap of at least 20%, it is ensured that at least a subset of the lubricoolant fluid can reach the chip space and the (from the perspective of the through-hole, possibly located behind the chip space) cutting edge.

In an exemplary embodiment, the cross-section of the through-hole protrudes by at least 50% when viewed according to the above conventions over the chip breaker groove. In an exemplary embodiment, the cross-section of the through-hole protrudes by at least 80% when viewed according to the above conventions over the chip breaker groove. In an exemplary embodiment, the cross-section of the through-hole protrudes completely (by 100%) when viewed according to the above conventions over the chip breaker groove. It is understood that the through-hole should not be positioned too far “above” and away from the chip breaker groove. In an exemplary embodiment, therefore, an intersection of a longitudinal axis of the through-hole with the outlet opening (mouth) of the through-hole towards the chip space is located above the chip breaker groove but less than three or two times the effective diameter of the cross-section of the through-hole in the mouth above the chip breaker groove. In other words, in exemplary embodiments, the through-hole with its effective cross-section is positioned just above the chip breaker groove.

It should be noted that the term “above the chip breaker groove” refers to the fact that the chip breaker groove itself defines a base/a bottom to which reference is made. It is understood that in operation, an arrangement “above the chip breaker groove” in view of a global reference (gravity, hall floor) may be below or laterally above the chip breaker groove.

The through-hole is in an exemplary embodiment at least partially oriented towards the chip breaker groove. There, the lubricoolant fluid can contribute to heat dissipation. Furthermore, the lubricoolant fluid can act as a lubricant to reduce friction, thus facilitating the removal and breaking of chips.

The chip space is a free space adjacent to a cutting edge, particularly located behind the cutting edge. The chip space serves to deflect and break the chips. In other words, the chip space is a free space above the chip breaker groove. During machining, the chips are formed in the chip space and removed via the chip space. Therefore, the chip guide surface is also exposed to high thermal stress. It is therefore advantageous to orient the through-hole at least partially towards the chip space.

According to an exemplary embodiment of the method or the device, the mold body is positioned in the cavity such that a longitudinal axis of the resulting through-hole is oriented at an angle of 45° to 90°, particularly at an angle of 60° to 90°, to the direction of the cutting motion. The through-hole is, for example, orthogonal or at least at an angle of 45° (obtuse angle) to the direction of the cutting motion. The through-hole is thus not parallel or acute to the direction of the cutting motion. This ensures a favorable feed direction for the lubricoolant fluid.

The angle of 45° to 90° includes a range of 90°+/−45°. The angle of 60° to 90° includes a range of 90°+/−30°. By way of example, the angle between the longitudinal axis of the through-hole and the direction of the cutting motion is 75° to 90°, this includes angles of 90°+/−15°.

According to an exemplary embodiment of the method or the device, the mold body is positioned in the cavity such that a longitudinal axis of the resulting through-hole is oriented at an angle of 0° to 45°, particularly parallel, to a plane defined as the average plane of a chip breaker groove geometry. This includes angles of 0°+/−45°. The average plane of the chip breaker groove geometry is exemplarily oriented orthogonal or substantially orthogonal to the direction of the cutting motion. The longitudinal axis of the through-hole is parallel or acute to the average plane of the chip breaker groove geometry.

According to an exemplary embodiment of the method or the device, the mold body is positioned in the cavity such that the resulting through-hole is oriented at an angle between 0° and 45° (0°+/−45°), particularly parallel to a main extension direction of a shaft of the pressed article. According to a further exemplary embodiment, the resulting through-hole is oriented at an angle between 0° and 30° (0°+/−30°) to the main extension direction of the shaft. According to a further exemplary embodiment, the resulting through-hole is oriented at an angle between 0° and 15° (0°+/−15°) to the main extension direction of the shaft.

According to an exemplary embodiment of the method or the device, the feed direction of the mold body is orthogonal to the main pressing direction of the cavity. If the main pressing direction is vertically oriented, according to this embodiment, the feed direction of the mold body is horizontal. The mold body can be referred to as a horizontal slider.

According to an exemplary embodiment of the method or the device, the mold body is arranged in the cavity in the neutral phase in the pressed article or at least adjacent to the neutral phase in the pressed article. According to an exemplary embodiment of the method or the device, the mold body is arranged in the cavity at least substantially in the neutral phase in the pressed article or at least adjacent to the neutral phase in the pressed article.

This applies at least approximately. The neutral phase is the section of the hard metal powder in the cavity that is not moved or only minimally moved during compression of the hard metal powder. When compressing the hard metal powder, the powder in the edge area of the pressed article is moved over considerable distances, for example by a punch acting directly on it. However, there is an area in the center of the cavity (neutral phase) where the hard metal powder is only slightly moved during the pressing process compared to powder in the edge area. It is conceivable to design the pressing tool (device) and the pressed article in such a way that the mold body is positioned in an area with only slight powder movement during compression. This reduces any forces acting on the mold body during compression by an (at least approximately) arrangement in the neutral phase, especially if the mold body is positioned orthogonally or otherwise obtusely relative to a main pressing direction.

It is understood that the term neutral phase does not necessarily imply that there must be no movement at all at the microscopic level. Instead, it refers to an area in the cavity that experiences only minimal movements/displacements under given conditions.

At least in exemplary embodiments, this arrangement allows only low shear forces to act on the rod-shaped operative section of the mold body during the compression of the hard metal powder. This prevents damage or even breaking of the mold body during compression.

According to an exemplary embodiment of the method or the device, the chip space of the pressed article is at least sectionally defined by the operative surface of the movable mold part. In other words, the mold part defines the chip space and consequently also the chip breaker groove. Another surface of the mold part, however, can serve as the abutment area for the mold body. In this way, a favorable orientation of the through-hole towards the chip space and chip breaker groove can be achieved.

According to an exemplary embodiment of the method or the device, the chip space of the pressed article is at least sectionally defined by another movable mold part. According to this embodiment, the (first-mentioned) mold part partially forms the geometry of the pressed article and also serves as the abutment area for the mold body. The further (last-mentioned) mold part forms at least sectionally the chip breaker groove and the chip space, possibly also a cutting edge geometry. From the perspective of the front face of the exemplarily rod-shaped mold body, the first-mentioned mold part is positioned between the mold body and the last-mentioned mold part. In this way, a favorable orientation of the through-hole towards the cutting edge, chip breaker groove, and chip space can be achieved.

If at least one (first) mold part defines the abutment area for the mold body and at least one (second) mold part defines the chip breaker groove and the chip space, the mold parts can generally also include different feed directions. By way of example, the first mold part has a vertical feed direction. By way of example, the second mold part has a horizontal feed direction. It is also conceivable that both mold parts have parallel feed directions.

If at least one (first) mold part defines the abutment area for the mold body and at least one (second) mold part defines the chip breaker groove and the chip space, it is conceivable to design one mold part as a punch and another mold part as a slider. However, it is also conceivable to design both mold parts as punches. This includes arrangements where one of the two mold parts is a vertical punch and another of the two mold parts is a horizontal punch/cross punch.

In an exemplary embodiment using a first mold part and a second mold part, the feed direction of the mold body is orthogonal to the feed direction of the first mold part and orthogonal to the feed direction of the second mold part, regardless of whether the feed direction of the first mold part and the second mold part are parallel or orthogonal to each other.

According to an exemplary embodiment of the method or the device, at least the chip space and the through-hole are formed with little or no post-processing in terms of their geometry in the die. In certain embodiments, this applies to the entire pressed article. In this way, the through-hole with its favorable orientation can be produced without significant additional effort within the pressing cycle. It is understood, however, that there are still other obligatory processing steps, for example, sintering to produce the cutting tool based on the pressed article (green body).

According to an exemplary embodiment of the method or the device, the mold body is positioned in the cavity such that an outlet opening of the through-hole facing the chip space is arranged on a surface of the pressed article that is oriented at an angle of 0° to 45° (0°+/−45°), particularly at an angle of 0° to 30° (0°+/−30°) to the direction of the main pressing direction. The outlet opening can also be referred to as a mouth. In the area of the outlet opening, the front face of the mold body comes into contact with/in the mold part. In an exemplary embodiment, the surface of the exit opening is parallel or almost parallel to the main pressing direction.

According to an exemplary embodiment of the method or the device, the mold part and the mold body are brought into a powder-tight relative position before filling the cavity with the hard metal powder. The powder-tight relative position does not necessarily have to correspond to the final relative position after the pressing process. This includes, for example, a powder-tight positioning of the front face of the mold body on a flat surface of the mold part, although the mold part can nevertheless later be moved along its flat surface along the front face. In an exemplary embodiment, however, at least the mold body is brought into a powder-tight intermediate position or even final end position in the cavity relative to the die before filling the cavity.

According to an exemplary embodiment of the method or the device, the mold part and the mold body are brought into a powder-tight relative position after filling the cavity with the hard metal powder. This includes, for example, an arrangement where hard metal powder in the cavity is initially displaced by the mold body until it reaches a powder-tight intermediate position or even final end position in the cavity. Then, the mold part can be fed and moved into the cavity. The mold part is, for example, arranged to displace powder in front of the front face of the mold body. This takes place due to the close powder-tight relative position, which nevertheless allows relative movement between the mold part and the mold body.

According to an exemplary embodiment of the method or the device, at least the mold part or the mold body is actively moved after filling the cavity with the hard metal powder. By way of example, the mold part serves as a punch that further contributes to the compression of the hard metal powder. The movement of the mold part and/or the mold body can occur in a powder-tight relative position.

According to an exemplary embodiment of the method or the device, the step of feeding the mold part and the mold body includes engaging the front face of the mold body into a resting recess in the mold part. In certain embodiments, the resting recess is sealed in a powder-tight manner.

In addition to a flush abutment, at least a sectional engagement of the mold body with its operative section in a recess on the mold part is also conceivable. Due to the different feed directions, the mold part and the mold body are interlocked with each other in this way. At least a partially form-fitting position securing results. In this way, for example, the mold body can be partially supported by the mold part during the pressing process.

According to an exemplary embodiment of the method or the device, the mold part has a closure for the resting recess, which seals the resting recess in a powder-tight manner when the mold body is not engaged. In this way, the ingress of powder into the resting recess can be avoided or minimized when the mold body is not yet engaged. Thus, the mold part and the mold body can be moved close to their final end position without hard metal powder accumulating in the resting recess.

According to an exemplary embodiment of the method or the device, the closure is arranged as a flexible closure. In an exemplary embodiment, the closure is displaced during the engagement of the mold body. In an exemplary embodiment, the closure is compressed during the engagement of the mold body. By way of example, the closure is arranged as a spring-loaded piston or spring-loaded flap, wherein the closure is moved by the mold body during engagement. It is generally also conceivable to design the closure as an elastic closure that is compressed or otherwise deformed by the mold body during engagement.

According to an exemplary embodiment of the method or the device, the step of feeding the mold part and the mold body includes a powder-tight arrangement of the front face of the mold body with respect to the abutment area on the mold part. In other words, a flush or nearly flush abutment of the front face of the mold body on/in the abutment area of the mold part can thus result. A target distance between the front face of the mold body and the abutment area of the mold part is greater than 0 but smaller than an average or minimum grain size of the hard metal powder. Ideally, therefore, no hard metal powder can enter an intermediate space (remaining gap) between the front face of the mold body and the abutment area in a given powder-tight arrangement, at least in exemplary embodiments.

A flush abutment of the front face of the mold body on an abutment surface of the abutment area of the mold part can also be an intermediate step if later the mold part at least partially engages in a resting recess on the mold part. The intermediate step already allows a powder-tight relative movement. In this way, for example, the mold body can be targeted with its front face opposite the resting recess by moving the mold part relative to the mold body.

According to an exemplary embodiment of the method or the device, the mold body assumes along its feed direction at least one abutment position, in which the mold part is moved relative to the front face of the mold body during a movement in its feed direction, thereby displacing any powder particles there. In other words, the mold part can thus clear the front face of the mold body like a stripper during the relative movement between the mold part and the mold body.

According to an exemplary embodiment of the method or the device, the feed direction of the mold part is parallel to the main pressing direction. Accordingly, the mold part can be provided as a punch, at least as a pre-press punch.

According to an exemplary embodiment of the method or the device, the feed direction of the mold part is orthogonal to the main pressing direction. According to an exemplary embodiment of the method or the device, the feed direction of the mold part is orthogonal to the feed direction of the mold body. By way of example, the mold part can be arranged as a side slider with a rod-shaped operative section.

According to an exemplary embodiment of the method or the device, the mold part is a punch. According to a further exemplary embodiment, the mold part contributes at least partially to the compression of the hard metal powder.

According to an exemplary embodiment of the method or the device, the mold part is a slider. A slider is particularly a mold part that is not or only insignificantly moved during a pressing process for compressing the hard metal powder. Insignificant are, for example, movements of the mold part that is arranged as a slider within the die during the pressing process, the amount of which is less than a tenth of the stroke of a main punch.

According to an exemplary embodiment of the method or the device, at least one further mold part is used in addition to the mold part, which is arranged as a punch, wherein the further mold part designed as a punch. In certain embodiments, the punch has a feed direction that is parallel or perpendicular to the feed direction of the mold part. This takes into account the fact that the cutting edge and the chip space with the chip breaker groove may also be defined by mold parts that are not used for powder-tight abutment with the mold body. These further mold parts can be main punches (vertical punches), side punches (cross punches), but basically also sliders.

According to an exemplary embodiment of the method or the device, the mold part is arranged as a pre-press punch and the further mold part as a punch, with a parallel feed direction, wherein the pre-press punch and the mold body in the cavity are moved towards each other through the introduced hard metal powder to be positioned powder-tight relative to each other, including at least partially compressing the hard metal powder by the pre-press punch, with the punch later moving parallel to the pre-press punch but with a greater compression stroke. In certain embodiments, the punch forms a significant section of an area in the pressed article that delimits the through-hole along its longitudinal extension.

In this way, it can be ensured that on the one hand, the powder-tight abutment of the mold body on the mold part is made possible and that, on the other hand, during the main pressing process, a significant portion of the pressed article is subjected to pressure to the desired extent.

In an exemplary embodiment, the mold body is positioned in the neutral phase so that the hard metal powder there is only slightly moved during compression.

It is to be understood that the previously mentioned features of the present disclosure and the features explained in the following may not only be used in the receptively specified combination, but also in other combinations or as isolated features without departing from the spirit and scope of the present disclosure.

### BRIEF DESCRIPTION OF THE DRAWINGS

Further features and advantages are disclosed by the following description of a plurality of exemplary embodiments, with reference to the drawings, wherein:

FIG. 1: is a top view of a cutting tool supported on a holder;

FIG. 2: is a broken side view of the cutting tool according to FIG. 1;

FIG. 3: is a perspective frontal view of the cutting tool according to FIGS. 1 and 2;

FIG. 4: is another view according to FIG. 3 with a partially sectional view of the cutting tool to illustrate a through-hole;

FIG. 5: is a frontal view of the cutting tool according to FIGS. 3 and 4, wherein the viewing plane is perpendicular to an axis of the through-hole;

FIG. 6: is another frontal view of the cutting tool based on FIG. 5 to illustrate various conceivable positions of the through-hole;

FIG. 7: is a longitudinal section through the cutting tool according to FIGS. 3-6, wherein the sectional plane lies in the axis of the through-hole;

FIG. 8: is a simplified view of a device for producing a hard-metal pressed article that includes a die;

FIG. 9: is a further view of the device based on FIG. 8, wherein a filling shoe for filling a cavity with a hard metal powder is arranged above the die;

FIG. 10: is a further view of the device according to FIGS. 8 and 9, wherein mold parts arranged as punches are moved to a starting position for compressing the hard metal powder;

FIG. 11: is a view of the device based on FIG. 10, wherein at least one mold part arranged as a punch and a mold body with a rod-shaped operative section are at least partially moved into the cavity;

FIG. 12: is a view of the device based on FIG. 11, wherein the mold part and the mold body assume a powder-tight relative position in the cavity;

FIG. 13: is a detailed view based on FIG. 12, illustrating the relative position between the mold part and the mold body to illustrate an exemplary embodiment of the powder-tight positioning;

FIG. 14: is a further detailed view based on FIG. 12, illustrating the relative position between the mold part and the mold body to illustrate another exemplary embodiment of the powder-tight positioning;

FIG. 15: is a view of the device based on FIG. 12, wherein involved punches in the cavity of the die have reached an end position for compressing the hard metal powder, thereby forming a pressed article;

FIG. 16: is a view of the device based on FIG. 15, wherein the mold body is moved out of a through-hole formed in the pressed article;

FIG. 17: is a view of the device based on FIG. 16, wherein upper punch parts are moved out of the cavity;

FIG. 18: is a view of the device based on FIG. 17, wherein a lower punch brings the pressed article out of the cavity;

FIG. 19: is a simplified side view of another exemplary embodiment of a pressed article having two through-holes;

FIG. 20: is a simplified perspective view of another pressed article with a through-hole to illustrate a tool concept modified from the device according to FIGS. 8-18;

FIG. 21: is a simplified view of another embodiment of a device for producing a hard-metal pressed article that is modified in relation to the device according to FIGS. 8-18; and

FIG. 22: is a simplified block diagram to illustrate an exemplary embodiment of a method for producing hard-metal pressed articles, particularly for producing sinter raw parts for cutting tools.

### EMBODIMENTS

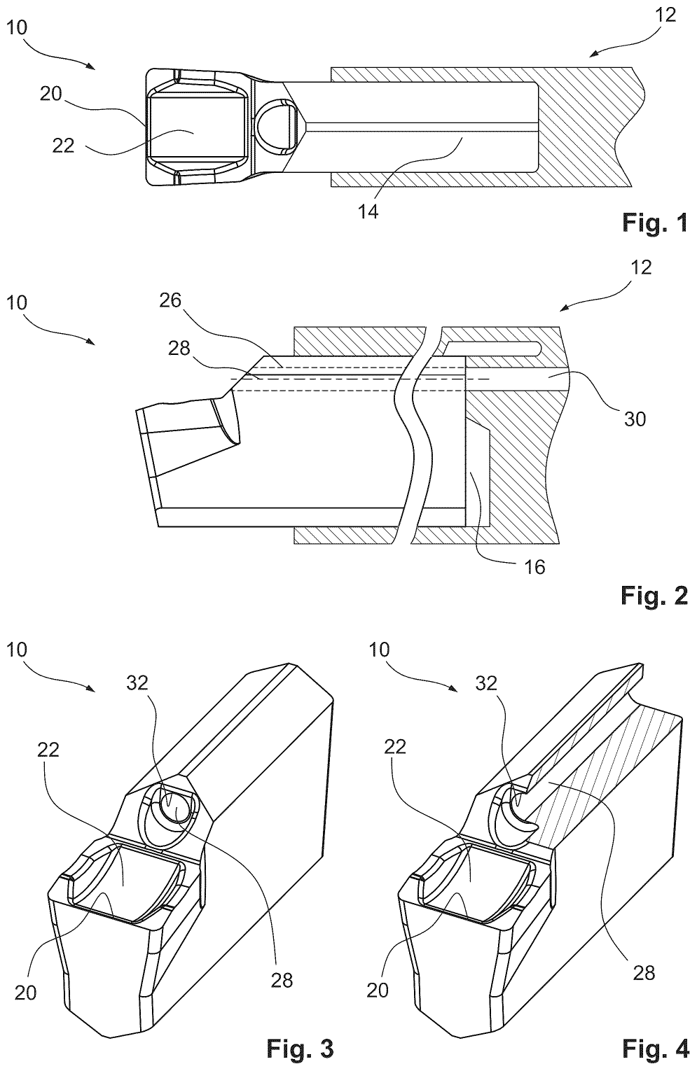

With reference to FIGS. 1-7, exemplary embodiments of cutting tools 10 are illustrated, the production of which is the subject of various aspects of the present disclosure. As already stated, the cutting tool 10 shown in top view in FIG. 1 can be produced based on a pressed article (green body) that has been produced under high pressure by compressing hard metal powder.

In FIGS. 1 and 2, it is indicated that the cutting tool 10 is taken up in a holder 12 during use. The cutting tool 10 is made, at least in exemplary embodiments, of hard metal materials. The cutting tool 10 includes a shaft 14 that is seated in a mount 16 of the holder 12 for clamping the cutting tool 10. The cutting tool 10 includes a cutting edge 20 adjoined by a chip breaker groove 22, refer also to the perspective views of FIGS. 3 and 4. The chip breaker groove 22 can also be referred to as a chip trough.

From FIGS. 2-4, it can be seen that the cutting tool 10 has a through-hole 26 which, in the exemplary embodiment, forms a lubricoolant channel 28 for coolant-lubricants. FIG. 2 shows that a lubricoolant supply 30 for providing lubricoolant fluid is associated with the lubricoolant channel 28 on the part of the holder 12. In this way, lubricoolant fluid can be introduced into the lubricoolant channel 28 and exit through an outlet opening 32 (FIG. 3 and FIG. 4) towards the chip breaker groove 22 and the cutting edge 20. The perspective views of FIGS. 3 and 4 illustrate the path of the lubricoolant channel 28 in the cutting tool 10.

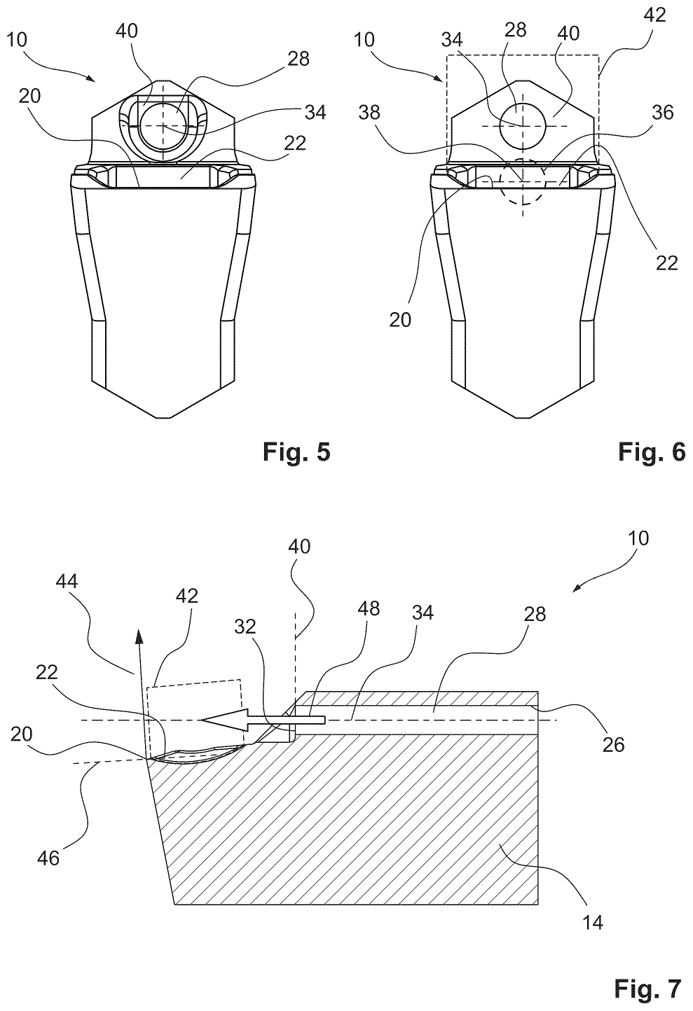

The orientation of the lubricoolant channel 28 and the through-hole 26 forming it, respectively, is further illustrated with reference to FIGS. 5-7. FIGS. 5 and 6 show frontal views of the cutting tool 10, where the viewing plane is perpendicular to an axis 34 of the lubricoolant channel 28. In this orientation, it can be seen that the outlet opening 32 (and/or a cross-section) of the through-hole 26 is arranged above the (frontal) cutting edge 20 as-in this case-the highest point of the chip breaker groove 22 when viewed in extension of the lubricoolant channel 28 and its axis 34, respectively. As previously indicated, the term “above” refers to the highest point of the chip breaker groove 22 in an extension of the lubricoolant channel 28, which essentially forms the reference for the chosen arrangement. If one were to look from the back along axis 34 through the lubricoolant channel 28 towards the cutting edge 20, the cross-section of the lubricoolant channel 28 would have to be at least partially above the section of the cutting edge 20 visible from this view, which section is in front of the lubricoolant channel 28.

FIG. 6 illustrates, in addition to FIG. 5, other possible positions of the outlet opening 32 and the lubricoolant channel 28, respectively. A dashed circle illustrates an alternative positioning of a lubricoolant channel 36 having an axis 38. The lubricoolant channel 36 is positioned with its cross-section at least partially above the chip breaker groove 22. In various embodiments, an arrangement of the through-hole 26 with its cross-section at the outlet opening 32 is provided at least partially above the chip breaker groove 22 and at least partially above the cutting edge 20.

In FIGS. 5-7, reference numeral 40 illustrates a surface on which the outlet opening 32 is arranged. In the exemplary embodiment, the surface 40 is oriented orthogonally to the axis 34 of the through-hole 26. With the present design of the cutting tool 10, the surface 40 and the outlet opening 32 can be produced directly in the die by two contacting mold parts (mold part and mold body) with different feed directions. This includes, for example, orthogonal feed directions.

Additionally, FIGS. 6 and 7 illustrate a chip space designated by 42 that is located above the chip breaker groove 22. The selected representation by dashed lines is merely exemplary. The cutting edge 20, the chip breaker groove 22, and the chip space 42 are highly stressed during machining with the cutting tool 10. Therefore, a general goal is to fed the lubricoolant fluid (compare arrow 48 in FIG. 7) with a favorable orientation to the cutting edge 20, the chip breaker groove 22, and the chip space 42.

FIG. 7 additionally shows, by an arrow 44, a direction of the cutting motion during machining with the cutting tool 10. The cutting motion 44 is the movement of the cutting tool 10 relative to the workpiece to be machined (not shown in FIG. 7). Reference numeral 46 illustrates, by a dashed line, a plane that is orthogonal to the direction of the cutting motion 44 and contacts the highest point of the chip breaker groove 22-in this case in extension of the axis 34 and the lubricoolant channel 28, respectively. The plane 46 serves in the exemplary embodiment also to illustrate the global orientation of the chip breaker groove 22.

According to exemplary embodiments, the through-hole 26 with its outlet opening 32 and/or the cross-section there, is positioned at least partially above the plane 46. The arrangement at least partially above the plane 46 exemplarily concerns at least 20% of the cross-section of the outlet opening 32. It is understood that further values such as 50%, 80%, or 100% are conceivable. At 100%, the through-hole 26 with its outlet opening 32 is completely above the plane 46. The mentioned orientations allow a large part of the lubricoolant fluid 48 to be specifically fed to the cutting edge 20, the chip breaker groove 22, and/or the chip space 42.

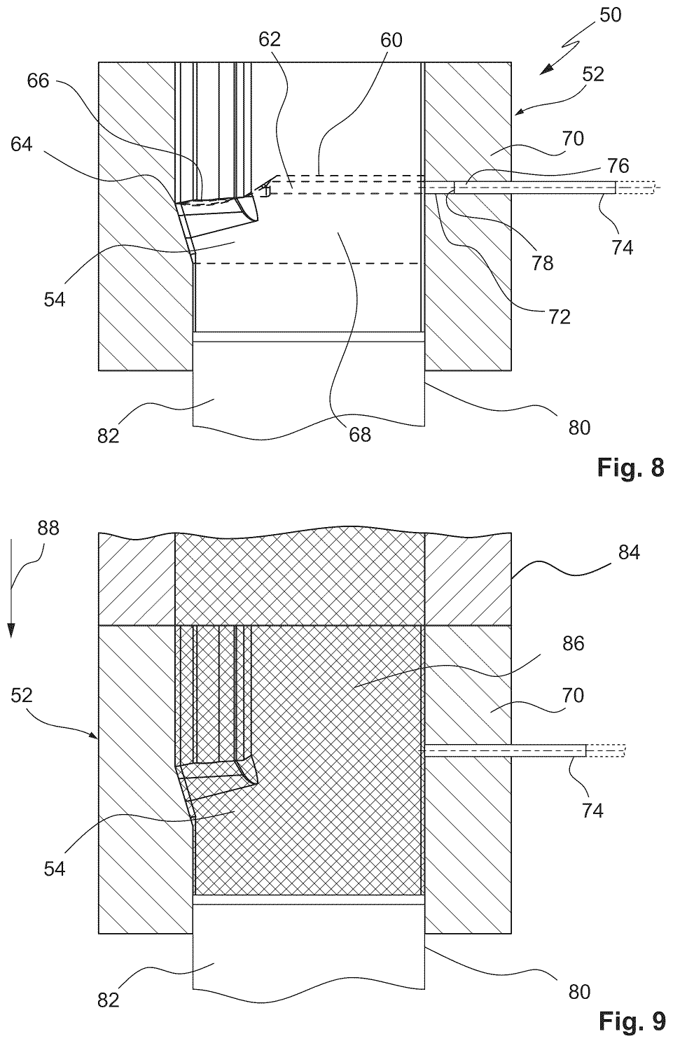

With reference to FIGS. 8-18, approaches to the manufacturing of blanks (pressed articles, green bodies) suitable for producing the cutting tool 10 according to FIGS. 1-7 or comparable cutting tools are illustrated.

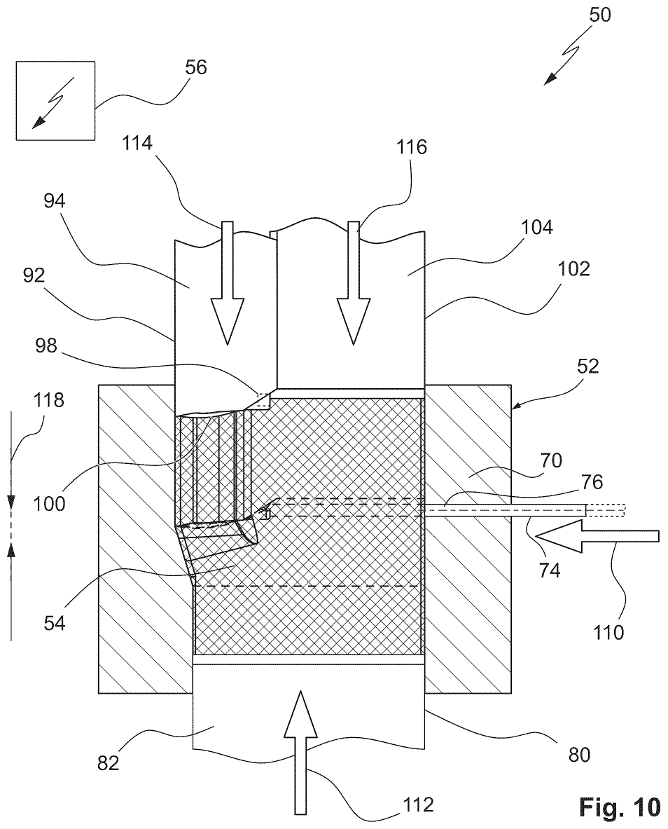

FIG. 8 illustrates a device 50 for manufacturing hard-metal pressed articles for producing raw parts for cutting tools. The device 50 comprises a die 52 that includes movable and immovable parts to form a cavity 54. In the cavity 54, hard-metal powder can be compressed to form a pressed article 60, the shape of which is the basis for the manufacture of the cutting tool 10. FIG. 10 additionally illustrates a control unit designated by 56 that suitably controls the device 50 and its components for producing pressed articles 60.

The pressed article 60 is indicated in FIG. 8 by a dashed representation. The pressed article 60 includes a through-hole 62 that is directed towards a cutting edge 64 and/or a chip breaker groove 66 and an imaginary chip space above the chip breaker groove 66. Compare the foregoing remarks in connection with FIGS. 5-7. The pressed article 60 further includes a shaft 68.

The die 52 of the device 50 comprises at least one stationary mold part 70 which, in the exemplary embodiment, defines at least sectionally a circumference of the pressed article 60. A guide 72 for a mold body 74 is provided in the stationary mold part 70. The mold body 74 is exemplarily designed as a slider. The mold body 74 has an operative section 76 that is approximately rod-shaped or pin-shaped. Towards the cavity 54, a front face 78 is provided that forms an end of the operative section 76. The operative section 76 defines the through-hole 62 in the pressed article 60. The die 52 exemplarily includes additional mold parts, such as a movable mold part 80 that is exemplarily configured as a lower punch 82.

In the configuration shown in FIG. 8, the cavity 54 of the die 52 can be filled with a hard-metal powder 86. This is illustrated in FIG. 9. For the purpose of filling, a so-called filling shoe 84 is fed on the side of the cavity 54 opposite the lower punch 82. Hard-metal powder 86 can trickle into the cavity 54 supported by gravity (compare the arrow 88 illustrating gravity). FIG. 9 also illustrates that the mold body 74 has been moved to a ready position with respect to the cavity 54. After filling with the filling shoe 84, a sufficient amount of hard-metal powder 86 for forming a pressed article is present in the cavity 54 of the die 52.

The orientation illustrated with reference to the arrow 88 (gravity) can also be used within the scope of the present disclosure to define terms such as above, top, below, bottom, lateral, transverse, and the like. The arrow 88 is parallel to a vertical. A horizontal plane extends orthogonally and/or perpendicularly to arrow 88. The person skilled in the art is aware that filling with the filling shoe 84 usually occurs “from above.”

FIG. 10 illustrates a state of the device 50 in which the filling shoe 84 (FIG. 9) has been moved away from the top of the die 52. This provides space for further mold parts, compare a movable mold part 92 exemplarily configured as an upper punch 94. By way of example, the mold part 92 has a dashed-indicated resting recess 98, although this is not obligatory.

The mold part 92 has an operative surface 100 that at least sectionally defines the shape of the pressed article 60. In the exemplary embodiment according to FIG. 10, the operative surface 100 at least sectionally defines the chip breaker groove 66 and the cutting edge 64, compare in this connection FIG. 8 and also FIG. 17. In the exemplary embodiment, a further movable mold part 102 is adjacent to the mold part 92, and is exemplarily arranged as another upper punch 104. The mold part 102 defines an area of the pressed article 60 in which the through-hole 62 to be formed by the operative section 76 of the mold body 74 extends.

In the exemplary embodiment, the mold body 74 has a horizontal feed direction 110. In the exemplary embodiment, the mold part 80 (lower punch 82) has a vertical feed direction 112, directed upwards. The mold part 92 (upper punch 94) has a vertical feed direction 114, directed downwards. The mold part 102 (upper punch 104) has a vertical feed direction 116, directed downwards.

As previously indicated, the control unit 56 serves to precisely and accurately control the movement of the various movable components of the device 50. In particular, movements of the mold body 74 and movements of the mold parts 80, 92, 102 (compare the feed directions 110, 112, 114, 116) can be precisely and accurately controlled, possibly even in the micrometer range.

Furthermore, FIG. 10 illustrates by an arrow 118 the main pressing direction 118 of the mold parts 80, 92, and 102 in the die 52 of the device 50. In the exemplary embodiment, both the lower punch 82 and the upper punches 94, 104 are moved towards each other at least sectionally. A vertically oriented main pressing direction 118 results.

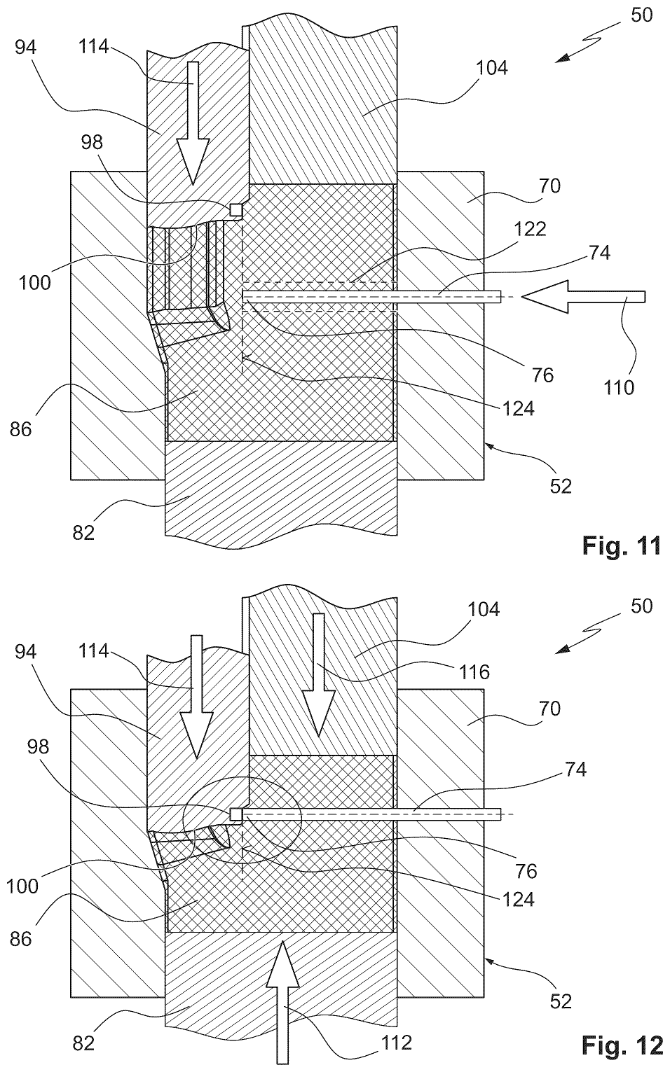

FIG. 11 illustrates a state in which the mold body 74 has been moved in its feed direction 110 into the cavity 54, displacing hard-metal powder 86 there. The mold body 74 has approached an abutment area 124 which, in the exemplary embodiment, is defined by the upper punch 94. The abutment area 124 corresponds, in the cutting tool 10 illustrated with reference to FIGS. 1-7, to the surface 40 on which the outlet opening 32 of the through-hole 26 is arranged. FIG. 11 also illustrates that, in the exemplary embodiment, the punches 82, 94, 104 are not necessarily moved synchronously and simultaneously. Rather, the arrow 114 shows that the punch 94, for example, moves ahead of the punch 104. The goal of the movement of the punch 94 (mold part 92) and the movement of the mold body 74 is a favorable relative position, particularly a powder-tight relative position.

FIG. 11 further illustrates, by reference numeral 122, a so-called neutral phase. The neutral phase 122 is a volume area during the pressing process where only relatively minor movements occur during the compression of the hard-metal powder 86. The control unit 56 of the device 50 can specifically control the mold parts 80, 92, 102 (i.e., the punches 82, 94, 104, for example) so that the neutral phase 122 results in the vicinity of the operative section 76 of the mold body 74. Thus, if the mold body 74 is positioned in the neutral phase 122, stresses on the mold body 74 are reduced during the pressing process.

FIG. 12, based on FIG. 11, illustrates a state in which the upper punch 94 (mold part 92) contacts the mold body 74 in a powder-tight manner. The upper punch 94 has almost or completely reached its final end position in the cavity 54. The operative surface 100 forms there a section of the pressed article 60, for example, the cutting edge 64 and/or the chip breaker groove 66. The powder-tight contact between the mold body 74 and the punch 94 allows the formation of the through-hole 62 in the pressed article, where the through-hole 62 is formed during the pressing process in the die 92 and not by subsequent material removal processes.

FIG. 12 further illustrates that, following the pressing movement of the upper punch 94, the further upper punch 104 (arrow 116) and the lower punch 82 (arrow 112) can also be fed in the main pressing direction 118 to further compress the hard-metal powder 86. The punches 94, 104, and 82 can be moved at least temporarily simultaneously.

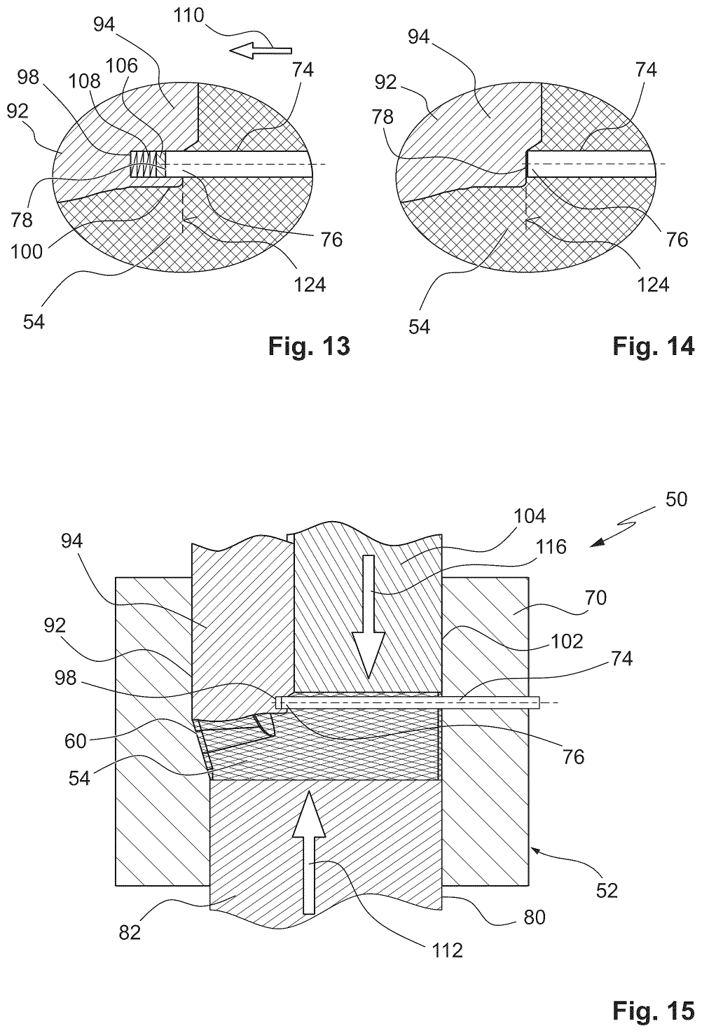

FIGS. 13 and 14 each illustrate, by means of a detailed view of the view shown in FIG. 12, conceivable designs of the desired powder-tight contact between the mold part 92 (upper punch 94) and the mold body 74.

In FIG. 13, it is shown that the mold body 74 with its operative section 76 and the frontal front face 78 can engage in the resting recess 98. If a corresponding circumferential gap is sufficiently small, a powder-tight relative position between the mold body 74 and the mold part 92 results. In the exemplary embodiment according to FIG. 13, a closure 106 is provided in the resting recess 98, which is designed, for example, as a closure piston or closure flap. The closure 106 can be pushed into the resting recess 98 by the mold body 74 against the force of a preloading element 108.

The engaging movement is illustrated by an arrow designated by 110. In other words, in this exemplary embodiment, the front face 78 of the mold body 74 moves beyond the abutment area 124 on the mold part 92. However, it is also conceivable that the mold body 74 with its front face 78 temporarily remains at the abutment area 124 during the feed movement. This allows the mold part 92 to be fed in its feed direction 114 after the mold body 74 has been fed, compare FIG. 11 in this context. If the front face 78 is oriented exactly opposite the resting recess 98 in the final position of the mold part 92, the mold body 74 with its front face 78 can move into the resting recess.

In exemplary embodiments, the closure 106 seals the resting recess 98 in a powder-tight manner, even during the feed movement (arrow 114 in FIGS. 11 and 12) of the mold part 92. In other words, the closure 106 can flush-seal the resting recess 98 so that the hard-metal powder 86 cannot accumulate there. This prevents the mold body 74 from possibly pushing any hard-metal powder 86 into the resting recess 98 during engagement.

FIG. 14 illustrates an alternative arrangement. According to this embodiment, a resting recess for the mold body 74 is dispensed with in the mold part 92 (upper punch 94). Instead, the powder-tight positioning is achieved by a flush contact of the front face 78 at the abutment area 124, which in FIG. 14 corresponds to the surface of the mold part 92 opposite the front face 78. The mold part 92 is exemplarily flat or planar in the area opposite the front face 78 so that relative movements between the mold body 78 and the mold part 92 in the feed direction 114 of the mold part 92 are conceivable while maintaining the powder-tight contact.

In this way, the mold body 74 with its front face 78 can be moved in its feed direction 110 to a final position in the cavity 54 (compare FIG. 11). The mold part 92 can then be fed its feed direction 114 and displace any hard-metal powder 86 in front of the front face 78 of the mold body 74. This also results in a powder-tight contact and thus the possibility to integrally form the through-hole 62 during the pressing process in the die 52.

The pressing process illustrated with reference to FIGS. 8-12 and 15-18 with the device 50 can basically be combined with any of the variants illustrated in FIGS. 13 and 14.

Based on the representation in FIG. 12, FIG. 15 illustrates a state in which all mold parts 80, 92, 102 (punches 82, 94, 104) have reached their final end position with respect to the cavity 54 and the hard-metal powder 86 contained therein. Similarly, the mold body 74 is in an end position with respect to the cavity 54. Consequently, the hard-metal powder 86 is compressed to such an extent that the desired pressed article 60 is formed.

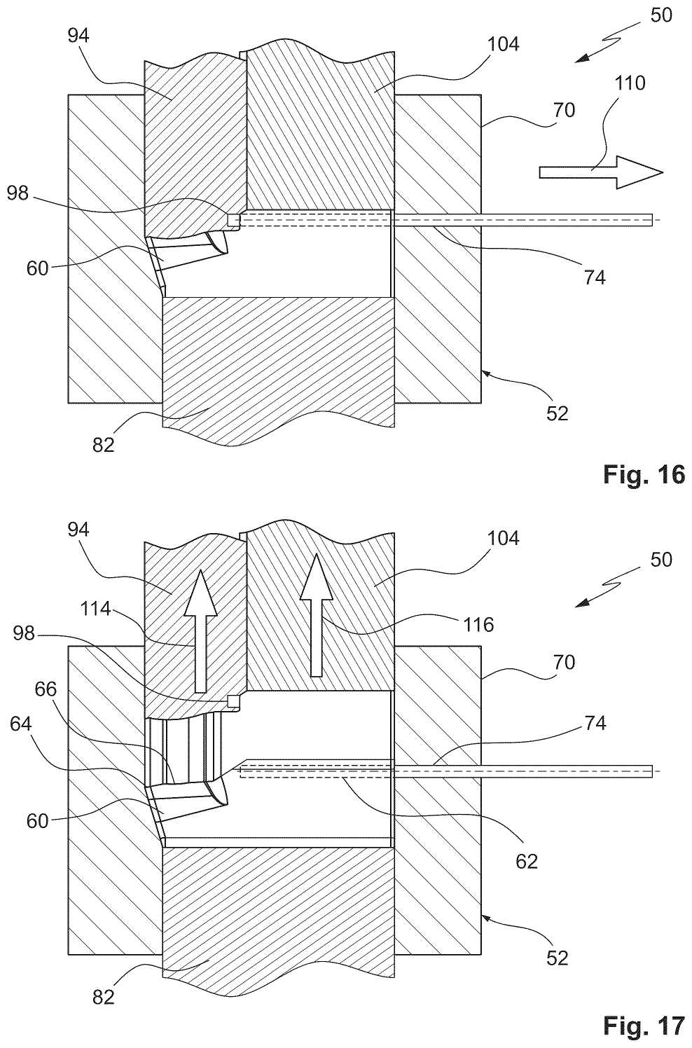

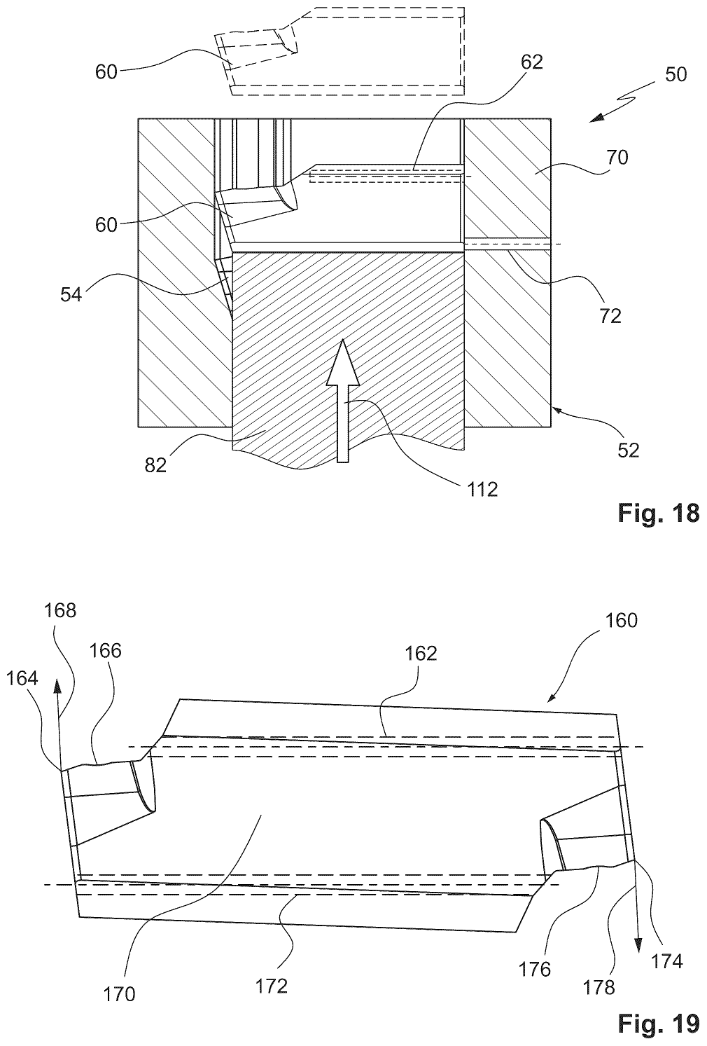

FIGS. 16 and 17 illustrate the beginning of the demolding process to recover the produced pressed article 60. In FIG. 16, the mold body 74 is first moved out of the cavity 54 (compare arrow 110). The through-hole 62 remains in the pressed article 60. FIG. 17 shows that the upper punches 94, 104 are lifted from the pressed article 60 and led upward out of the die 52 (compare arrows 114, 116). This exposes the cutting edge 64 and the chip breaker groove 66 of the pressed article 60. The pressed article 60 can then exemplarily be lifted by the lower punch 82 and led upward out of the die 52, compare the arrow 112 in FIG. 18. In FIG. 18, the obtained pressed article 60 is also illustrated outside the cavity 52 by a dashed representation. The pressed article 60 features an integrated through-hole 62.

FIG. 19 illustrates another exemplary embodiment of a pressed article 160 suitable for producing a reversible cutting insert with two cutting edges. The pressed article 160 has a through-hole 162 that can serve as a lubricoolant channel. The through-hole 162 is aligned with a cutting edge 164 and/or a chip breaker groove 166 adjacent to the cutting edge 164. An arrow designated by 168 illustrates the direction of the cutting motion during machining with the cutting edge 164. The cross-section of the through-hole 162 in the area of its mouth with respect to the chip breaker groove 166 is at least partially above a plane that is orthogonal to the direction of the cutting motion 168 and that contacts the cutting edge 164. A shaft of the pressed article is designated by 170.

In the exemplary embodiment, the pressed article 160 is arranged to be point-symmetrical. Consequently, the pressed article 160 also has a through-hole 172 that can serve as a lubricoolant channel. The through-hole 172 is aligned with a cutting edge 174 and/or a chip breaker groove 176 adjacent to the cutting edge 174. An arrow designated by 178 illustrates the direction of the cutting motion during machining with the cutting edge 174. The cross-section of the through-hole 172 in the area of its mouth with respect to the chip breaker groove 176 is at least partially above a plane that is orthogonal to the direction of the cutting motion 178 and intersects the cutting edge 174.

The pressed article 160 can be manufactured using powder pressing with a tool concept that is, for example, similar to the concept of the device 50 according to FIGS. 8-18. Other concepts according to alternative embodiments of the present disclosure are conceivable.

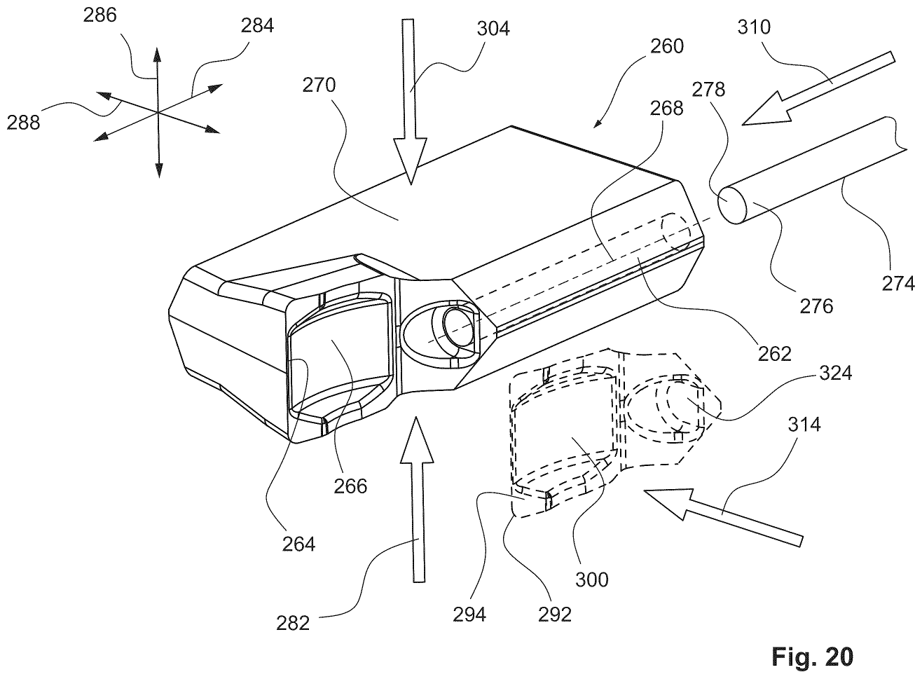

FIG. 20 illustrates, by means of a perspective representation of a pressed article 260, another alternative approach for a tool concept. The pressed article 260 is designed at least similarly to the pressed article 60 previously illustrated with reference to FIGS. 8-18. The pressed article 260 has a through-hole 262 which is favorably directed towards a cutting edge 264 of the pressed article 260 and a chip breaker groove 266 adjacent to the cutting edge 264. The through-hole 262 extends along an axis 268. The shaft of the pressed article 260 is designated by 270. To form the through-hole 262, a mold body 274 with an operative section 276 is provided, whose front face 278 faces the cutting edge 264 and the chip breaker groove 266, respectively, during the pressing process. The mold body 274 is exemplarily configured as a slider with a horizontal feed direction 310.

In FIG. 20, the pressed article 260 is shown in a lying orientation. Additionally, reference is made to a Cartesian coordinate system designated by 284, 286, 288. The arrow 284 illustrates a horizontal extension (for example, longitudinal extension). The arrow 286 illustrates a vertical. The arrow 288 illustrates a horizontal extension (for example, depth extension). The arrows 284, 288 together define a horizontal plane. The arrow 286 is orthogonal to this horizontal plane.

A comparison with FIGS. 8-18 shows that the pressed article 260 is tilted by 90°. In FIG. 20, an arrow 282 indicates a lower punch for producing the pressed article 260. Similarly, an arrow 304 indicates an upper punch. The punches 282 and 304 are provided opposite each other in a die (not shown in FIG. 20) and are movable towards each other in the vertical 286 to compress hard-metal powder to form the pressed article 260.

In the “lying” configuration according to FIG. 20, the cutting edge 264 and particularly the chip breaker groove 266 are formed by a laterally feedable mold part 292. An operative surface 300 of the mold part 292 is shown in FIG. 20 by dashed lines. The operative surface 300 corresponds to the desired design of the chip breaker groove 266 and the cutting edge 264, respectively, and forms them at least sectionally in the die. The feed direction (compare the arrow 314 in FIG. 20) is exemplarily parallel to direction 288. The mold part 292 is exemplarily configured as a lateral slider (cross slider) or as a lateral punch (cross punch 294).

The feed direction 314 is in the exemplarily embodiment orthogonal to the feed direction 310 of the mold body 274. The mold part 292 has an abutment area 324 where the mold body 274 with its front face 278 can come into powder-tight contact. Also in this way, a through-hole 262 with a favorable orientation in the pressed article 260 can be produced using a horizontally feedable mold part 292 and a horizontally feedable mold body 274.

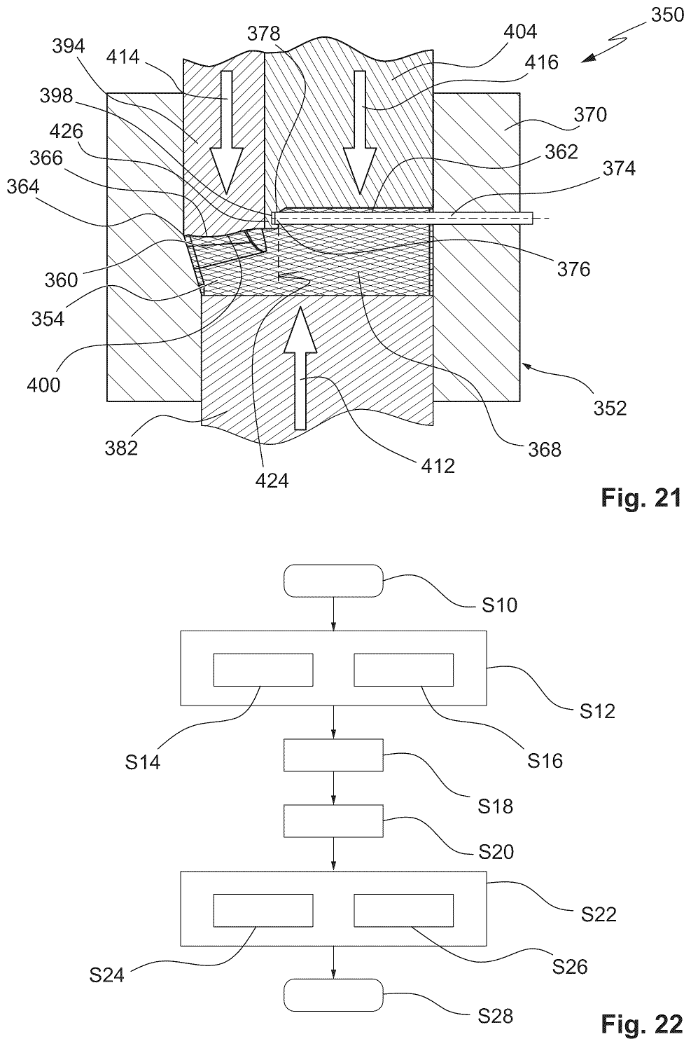

FIG. 21 illustrates another exemplary embodiment of a device for producing hard-metal pressed articles. The device is generally designated by 350. The device 350 is designed generally similarly to the device 50 illustrated with reference to FIGS. 818.

The device 350 comprises a die 352 for forming a cavity 354 in which a pressed article 360 from hard-metal powder can be produced. The pressed article 360 has a through-hole 362 that can serve as a lubricoolant channel, for example. The through-hole 362 is favorably oriented with respect to a cutting edge 364 and a chip breaker groove 366 adjacent to the cutting edge 364. The pressed article 360 has a shaft 368. In general, the pressed article 360 is also suitable for producing cutting tools 10, compare the design illustrated with reference to FIGS. 1-7, for instance.

In a manner generally already described above, the die 352 has at least one fixed mold part 370 that, defines a circumference of the pressed article 360, for instance. A guide for a mold body 374 is also provided in the fixed mold part 370, which mold body 374 has an operative section 376 that forms the through-hole 362. The operative section 376 has a front face 378.

In a manner generally already described above, the die 352 includes a mold part that is exemplarily configured as a lower punch 382 with a feed direction 412. Furthermore, a mold part is provided that is exemplarily configured as an upper punch 394 with a feed direction 414. The punch 394 has an operative surface 400 that is used in the exemplary embodiment to form the cutting edge 364 and the chip breaker groove 366.

A difference between the device 50 according to FIGS. 8-18 and the device 350 according to FIG. 21 is that the mold body 374 with its front face 78 does not come into contact with the punch 394, which with its operative surface 400 forms the chip breaker groove 366 and the cutting edge 364. Instead, the die 352 includes another mold part that is exemplarily configured as (another) upper punch 404 with a feed direction 416. The punch 404 defines a section of the shaft 368 of the pressed article 360 in which the through-hole 362 extends. Additionally, the punch 404 has an abutment area 424 for the mold body 374. In the exemplary embodiment, an extension 426 of the punch 404 forms the abutment area 424. There, for example, a resting recess 398 is formed, into which the operative section 376 with the front face 378 can penetrate.

In the abutment area 424, the mold body 374 can come into powder-tight contact with the punch 404. The configuration of the device 350 illustrated with reference to FIG. 21 is exemplarily suitable for pressed articles 360, where the cutting edge 364 and the chip breaker groove 366 are spaced from a mouth of the through-hole 362, even if this is not clearly shown in FIG. 21.

With reference to FIG. 22, an exemplary embodiment of a method for producing hard-metal pressed articles is illustrated with reference to a block diagram. The method is particularly suitable for producing sinter raw parts for cutting tools with an integrated lubricoolant channel. The method allows a favorable orientation of the lubricoolant channel with respect to a cutting edge and/or a chip breaker groove of the cutting tool. The method starts with step S10.

Step S12 refers to providing a die for forming a cavity for producing a pressed article by compressing hard-metal powder. Step S12 includes a sub-step S14 which involves providing a movable mold part that at least sectionally defines the shape of the pressed article with an operative surface. Step S12 further includes a sub-step S16 which involves providing a movable mold body that is exemplarily configured as a slider and serves to form a through-hole in the pressed article. The mold part and the mold body have different feed directions which are particularly obtuse or even orthogonal to each other. The mold body is exemplarily configured as a punch or slider.

In step S18, the mold part and the mold body are fed in such a way that a powder-tight contact of the mold body on the mold part is achieved. In this way, a through-hole can be formed during the pressing process. Step S18 can be combined with filling the cavity with hard-metal powder. It is generally conceivable to first fill the cavity with the hard-metal powder and then move the mold part and the mold body into the cavity. The feed movement of the mold body and the mold part can occur in a time staggered manner. At least in some instances, a temporally overlapping feed is conceivable. When the mold body is moved to a target position in the filled cavity, the mold part can be used to displace any hard-metal powder in front of the front face of the mold body.

In a further step S20, the hard-metal powder is compressed to obtain the pressed article. For this purpose, usually one punch or several punches are used. Generally, the mold part can be designed as a punch and contribute to the compression. Another step S22 involves demolding the pressed article. This includes, for example, in a sub-step S24, moving out the mold body and in a sub-step S26, moving out the mold part from the cavity.

The method ends with a step S28. The pressed article is available for further manufacturing steps (for example, sintering).

What is claimed is:

1. A method for producing hard-metal pressed articles for the production of sinter raw parts for cutting tools, the method comprising the following steps:
providing a die that forms a cavity for producing a pressed article having at least one cutting edge and at least one chip breaker groove that is associated with a chip space, comprising:
providing a movable mold part having an operative surface, wherein the mold part at least sectionally defines the shape of the pressed article with the operative surface, and wherein the mold part is feedable in a first feed direction,
providing a movable mold body having a rod-shaped operative section for creating a through-hole in the pressed article, wherein the mold body is feedable in a second feed direction, and wherein the first feed direction and the second feed direction are inclined at an angle of at least 45° to each other,
forming the pressed article from a hard-metal powder that is introduced into the cavity and compressed there in at least one main pressing direction, comprising:
feeding the mold part and the mold body such that the mold body is positioned in the cavity with the operative section being disposed in an abutment area on the mold part in a powder-tight relative position to form the through-hole in the pressed article.

2. The method of claim 1,
wherein the mold body is positioned in the cavity such that the formed through-hole is directed towards the chip space of the pressed article.

3. The method of claim 1,
wherein the mold body is positioned in the cavity such that the formed through-hole is directed towards the chip breaker groove, and
wherein the cross-section of the through-hole protrudes by at least 20% over the chip breaker groove, when viewing at an outlet opening along a plane that is orthogonal to the direction of the cutting motion and that contacts the cutting edge.

4. The method of claim 1,
wherein the mold body is positioned in the cavity such that a longitudinal axis of the formed through-hole is oriented at an angle of 45° to 90° with respect to the direction of the cutting motion.

5. The method of claim 1,
wherein the mold body is positioned in the cavity such that the formed through-hole is oriented at an angle between 0° and 45° to a main extension direction of a shaft of the pressed article.

6. The method of claim 1,
wherein the feed direction of the mold body is orthogonal to the main pressing direction of the cavity.

7. The method of claim 1,
wherein the mold body is arranged in the cavity in the neutral phase in the pressed article or at least adjacent to the neutral phase in the pressed article.

8. The method of claim 1,
wherein the chip space of the pressed article is at least sectionally defined by the operative surface of the mold part.

9. The method of claim 1,
wherein the chip space of the pressed article is at least sectionally defined by another movable mold part.

10. The method of claim 1,
wherein at least the chip space and the through-hole are formed in the die with little or no post-processing being necessary in terms of their geometry.

11. The method of claim 1,
wherein the mold body is positioned in the cavity such that in the pressed article an outlet opening of the through-hole facing the chip space is arranged on a surface of the pressed article that is oriented at an angle of 0° to 45° with respect to the direction of the main pressing direction.

12. The method of claim 1,
wherein the mold part and the mold body are brought into the powder-tight relative position before filling the cavity with the hard-metal powder.

13. The method of claim 1,
wherein the mold part and the mold body are brought into the powder-tight relative position after filling the cavity with the hard-metal powder.

14. The method of claim 1,
wherein at least one of the mold part and the mold body are actively moved after filling the cavity with the hard-metal powder.

15. The method of claim 1,
wherein the mold body has a front face,
wherein the step of feeding the mold part and the mold body includes engaging a resting recess in the mold part with the front face of the mold body.

16. The method of claim 15,
wherein the mold part has a closure for the resting recess that seals the resting recess powder-tight when the mold body is not engaging.

17. The method of claim 16,
wherein the closure is arranged as a flexible closure that is displaced or compressed when the mold body engages the resting recess.

18. The method of claim 1,
wherein the mold body has a front face,
wherein the step of feeding the mold part and the mold body includes a powder-tight relative positioning between the front face of the mold body and the abutment area on the mold part.

19. The method of claim 18,
wherein the mold body assumes along its feed direction at least one abutment position, and
wherein, when the mold body is in the at least one abutment position, the mold part is moved relative to the front face of the mold body during a movement in its feed direction thereby displacing powder particles in front of the front face.

20. The method of claim 1,
wherein the feed direction of the mold part is parallel to the main pressing direction.

21. The method of claim 1,
wherein the feed direction of the mold part is orthogonal to the main pressing direction and orthogonal to the feed direction of the mold body.

22. The method of claim 1,
wherein the mold part is a punch that contributes to the compressing of the hard-metal powder.

23. The method of claim 1,
wherein the mold part is a slider.

24. The method of claim 1,
wherein in addition to the mold part, at least one further mold part is used that is arranged as a punch, and
wherein the further mold part has a feed direction that is parallel or perpendicular to the feed direction of the mold part.

25. The method of claim 24,
wherein the mold part is arranged as a pre-press punch and the further mold part is arranged as a punch, the mold part and the further mold part having parallel feed directions,
wherein the through-hole has a longitudinal extension, and
wherein the pre-press punch and the mold body are moved towards each other through the introduced hard-metal powder in the cavity to be positioned powder-tight relative to each other, comprising:
at least partially compressing of the hard-metal powder by the pre-press punch,
wherein the punch is subsequently moved parallel to the pre-press punch, but with a greater compressing stroke, to complete the compression, and
wherein the punch defines a region of the pressed article that closes off the through-hole along the longitudinal extension.

26. A device for producing hard-metal pressed articles for the production of sinter raw parts for cutting tools, comprising:
a die that forms a cavity for producing a pressed article having at least one cutting edge and at least one chip breaker groove that is associated with a chip space, comprising:
at least one movable mold part having an operative surface, wherein the mold part at least sectionally defines the shape of the pressed article with the operative surface, wherein the mold part is feedable in a first feed direction,
a movable mold body having a rod-shaped operative section for creating a through-hole in the pressed article, wherein the mold body is feedable in a second feed direction,
wherein the first feed direction and the second feed direction are inclined at an angle of at least 45° to each other,
wherein the cavity is arranged to be filled with a hard-metal powder,
wherein the device has at least one main pressing direction for compressing the hard-metal powder that is introduced into the cavity, and
wherein the mold part and the mold body are feedable such that the mold body is positioned in the cavity with the operative section being disposed in an abutment area on the first mold part in a powder-tight relative position to form the through-hole in the pressed article.
